(19) United States
(12) Patent Application Publication
(10) Pub. No.: US 2004/0022601 A1
(43) Pub. Date: Feb. 5, 2004

(54) Jackscrew with coating

(76) Inventors: Gregory Scott Meyer, Rocklin, CA (US); Alisa Sandoval, Grass Valley, CA (US)

Correspondence Address: HEWLETT-PACKARD COMPANY, Intellectual Property Administration, P.O. Box 272400, Fort Collins, CO, 80527-2400, US

(21) Appl. No.: 10/212,894

(22) Filed: Aug. 5, 2002

(51) Int. Cl. F16B 35/00

(52) U.S. Cl. 411/378

(57) ABSTRACT

A jackscrew for use in securing electronic assemblies preferably includes a threaded shaft, a head at one end of the threaded shaft, and a protective coating disposed on the threads of the threaded shaft. The protective coating prevents fragments from being dislodged from the jackscrew.

### FIELD OF THE INVENTION

The present invention relates to the field of screws. More particularly, the present application relates to the field of jackscrews used to secure electronic and computer components.

### BACKGROUND OF THE INVENTION

Jackscrews are specialized screws used in electronics and computer equipment. Jackscrews are used, for example, to attach printed circuit assemblies and other components in, or to, the housing or chassis of an electronics assembly or to other structural members in an electronic device.

Jackscrews typically have many threads per centimeter so as to make a very secure connection. The relatively high thread count makes it necessary to make relatively more radial turns of the jackscrew in order to thread the jackscrew completely into a threaded hole.

Often, jackscrews must be removed and reinserted in order to maintain, inspect, replace or repair components of the electrical device in which the jackscrew is used. With the amount of threads per centimeter on a typical jackscrew, this repeated removal and reinsertion of the screw causes significant wear and tear on the jackscrew. Frequently, this wear and tear causes fragments of the jackscrew to be dislodged, scratched off or otherwise worn from the jackscrew.

Having material dislodged from the threads or other parts of a jackscrew is disadvantageous for several reasons. For example, the jackscrew becomes less useful as a fastener as its threads become worn. The wearing of screw threads decreases the ability of a screw to make a tight connection and secure the components through which it is placed.

Another problem is that these fragments of screw threads can damage the electronics in which the screw is used. For example, these fragments can cause electrical shorts when they are brought into contact with printed circuit boards or other electronic components.

Additionally, metal shavings or slivers generated when a jackscrew or other type of screw is inserted into a threaded hole can cause binding between the screw and the threaded hole that is to receive the screw. This situation occurs especially in off-axis loading of the screw, where the screw may not be correctly aligned with the threaded receiving hole. Binding between these two members in this fashion will prevent the screw from being properly threaded into the hole and may create further metal contamination in electrical assemblies of all kinds.

### SUMMARY OF THE INVENTION

In one of many possible embodiments, the present invention provides a jackscrew for use in securing electronic assemblies. The jackscrew preferably includes a threaded shaft, a head at one end of the threaded shaft, and a protective coating disposed on the threads of the threaded shaft. The protective coating prevents fragments from being dislodged from the jackscrew.

### BRIEF DESCRIPTION OF THE DRAWINGS

The accompanying drawings illustrate various embodiments of the present invention and are a part of the specification. Together with the following description, the drawings demonstrate and explain the principles of the present invention. The illustrated embodiments are examples of the present invention and do not limit the scope of the invention.

FIGS. 1a and 1b illustrate a jackscrew to which the principles of the present invention may be applied.

FIG. 2 illustrates an end-on view of head of the jackscrew of FIGS. 1a and 1b.

FIG. 3 illustrates a conventional jackscrew with problematic fragments of metal worn from the jackscrew.

FIG. 4 is an illustration of one embodiment of the present invention in which a jackscrew is coated with a protective coating.

FIG. 5 is an illustration of an embodiment of the present invention showing the threaded portion of a coated jackscrew, which is being used in an electronics assembly.

FIG. 6 is an illustration of an embodiment of the present invention showing a threaded nut plate that would receive a jackscrew.

FIG. 7 is an illustration of an embodiment of the present invention showing a coated jackscrew, which is used in an electronics assembly and is secured in a threaded nut plate incorporated into the housing (or chassis) of the electronics assembly.

FIG. 8 is an illustration of an embodiment of the present invention in which a coated jackscrew resists damage during off-axis loading.

Throughout the drawings, identical reference numbers designate similar, but not necessarily identical, elements.

### DETAILED DESCRIPTION OF THE PREFERRED EMBODIMENTS

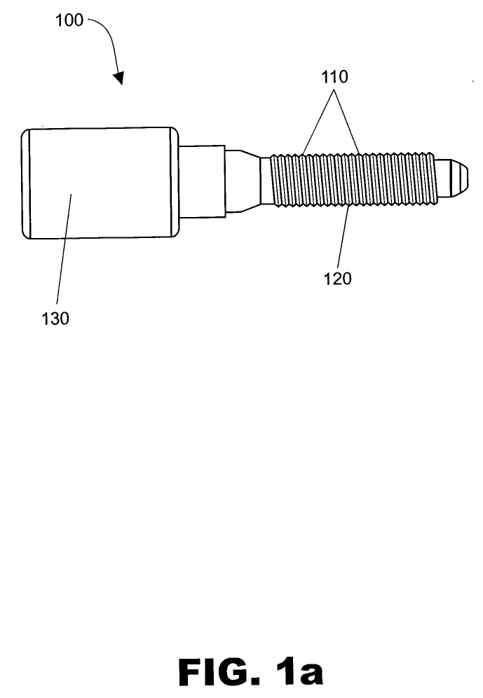

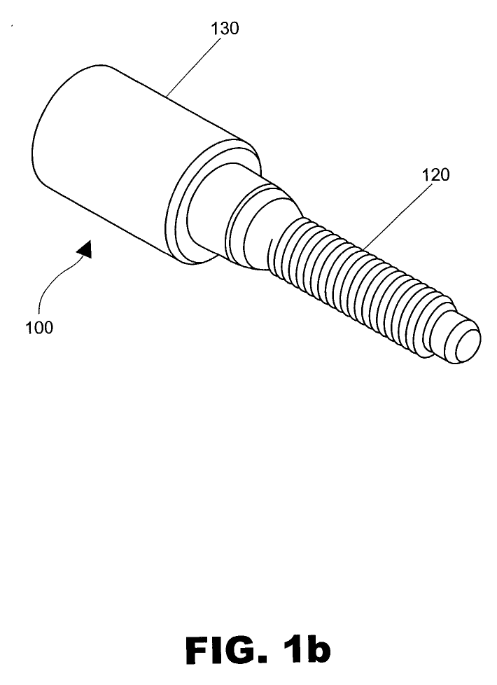

FIGS. 1a and 1b illustrate a jackscrew (100) that is used in electrical components. Jackscrews (100) are usually composed of a threaded shaft (120) and a head (130). The threads (110) are typically zinc-coated steel. The head (130) may have knurling around its circumference to facilitate the ability of a user of the jackscrew (100) to grip the head (130) for hand tightening of the jackscrew (100).

The jackscrew head (130) also includes a recess into which the tip of a tool, such as a screwdriver, can be inserted to drive the screw by rotation into or out of a threaded hole. This recess can have a wide variety of shapes, including, but not limited to, a single slot, cross-slots, a hexagon shape, a square shape, etc.

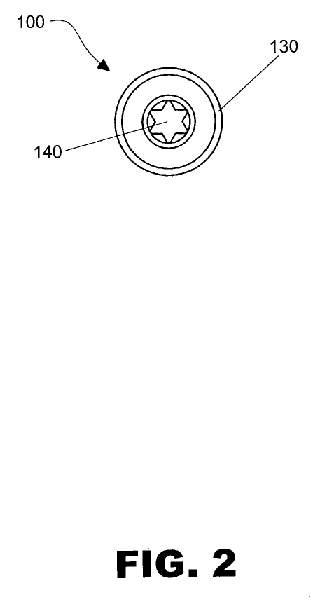

FIG. 2 is an illustration of a preferred recess (140) in the head (130) of a jackscrew (100). The recess (140) shown in FIG. 2 is star-shaped such that the screw (100) could be driven with an appropriately shaped tool tip inserted into the recess (140). Jackscrews with this type of recess (140) are made by Textron Industries, Inc. of Rockford, Ill. under the trademark TORX®.

Jackscrews (100) are typically used in conjunction with stainless steel nuts or nut plates that are threaded into in chassis or housing of an electronic device in order to hold a printed circuit assembly safely in the housing of that electronic device. This will be illustrated in greater detail below.

As indicated above, the threads (110) on the shaft (120) are relatively dense and close together, thus creating more threads (110) per centimeter than, for example, a conventional wood screw would have. Due to the case of wear that a jackscrew (100) of this composition can undergo, fragments of metal from the jackscrew (100) can be chipped, worn or otherwise dislodged from the jackscrew (100). This results in the wide variety of problems discussed above.

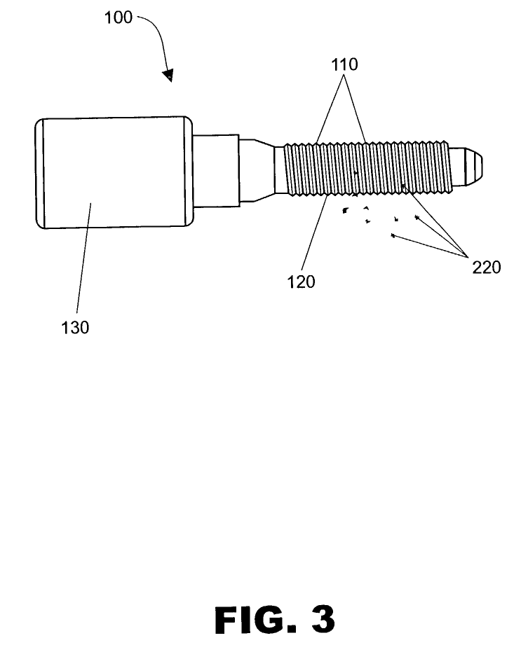

FIG. 3 illustrates a conventional jackscrew (100) with flakes of separated metal (220) that have been dislodged from the jackscrew (100). Often, during installation and removal of the jackscrew (100), these flakes of metal (220) will be produced. Installation of jackscrews (100) can often be off-axis, meaning that the male and female thread axis are misaligned when torque is applied to drive the screw into the threaded hole. This misalignment causes the threads (110) of the jackscrew (100) to bear down against the harder metal of the female portion of the system, i.e., the threads of the hole into which the screw is being seated. Consequently, flakes or fragments of metal (220) are sheared off the jackscrew (100).

These flakes or fragments of metal (220) that are produced from the jackscrew (100) can contaminate printed circuit assemblies and other vulnerable electronic components. Contamination of electronic assemblies with these flakes of metal (220) can cause electrical shorts due to the conductivity of the flakes or fragments (220). The more fragments of metal (220) produced that may come in contact with any electrical system in the electrical device, the more likely those fragments (220) are to cause a failure in the circuitry of the device.

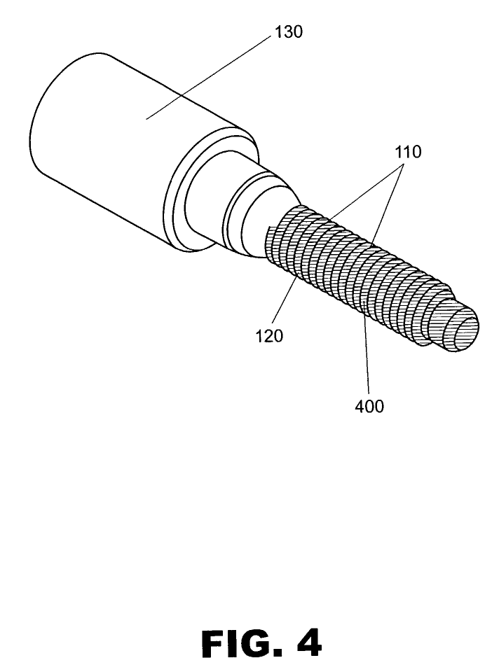

FIG. 4 illustrates an embodiment of the present invention in which a jackscrew (100a) is coated with a protective coating (400). Under the principles of the present invention, the protective coating (400) serves a number of purposes. First, the protective coating (400) covers the threads (110) of the screw (100a) to prevent flakes or fragments of metal from being sheared or worn off the screw (100a). The coating (400) may absorb pressure and force applied to the screw (100) that would otherwise tend to dislodge fragments of metal from the screw (100a). The coating (400) increases the surface strength of the screw (100a) and may hold fragments to the screw (100a) even if those fragments are broken from the surface of the screw (100a) under the coating. The coating (400) may be applied over the entire exterior surface of the jackscrew (100a), including the head (130) to prevent unwanted fragments from being dislodged from any part of the screw (100a).

Additionally, the protective coating (400) can cause the surface of the jackscrew (100a) to have a lower coefficient of friction. A lower coefficient of friction causes the jackscrew (100a) to rotate more freely as torque is applied in order to twist the jackscrew (100a) into the female portion of the system, i.e., into a threaded hole. Since the jackscrew (100a) rotates more freely as it is torqued, less binding of the jackscrew (100) in the nut or female portion of the system will occur. Consequently, fewer or no fragments of metal (220) will be broken off the jackscrew (100).

A preferred material for the protective coating (400) is Xylan® 1052. Xylan® is a chemical compound made by the Whitford Corporation of West Chester, Pa. The chemical compound of Xylan® 1052 (400) is composed of a unique combination of PTFE (polytetrafluoroethylene) and MoS₂ (molybdenum disulfide) chemical compounds.

Molybdenum disulfide (MoS₂) is a chemical known for its low coefficient of friction and high load-bearing properties. This chemical helps contribute to Xylan® 1052's (400) low coefficient of friction (“slipperiness”) and durability. PTFE (polytetrafluoroethylene) is a thermoplastic member of the fluoropolymer family of plastics. PTFE is considered to have the lowest coefficient of friction of any known solid, and the highest operating temperatures of the fluoropolymer family. These remarkable qualities allow this substance to eliminate wear on any jackscrew that is coated in Xylan® 1052 (400). Therefore, Xylan® 1052 makes a preferred protective coating (400) for jackscrews (100a) that may encounter wear and tear and heavy, off-axis load pressures. Through the application of Xylan® 1052 (400), metal particle (220) contamination among printed circuit assemblies and any other electronic assembly is minimized or eliminated.

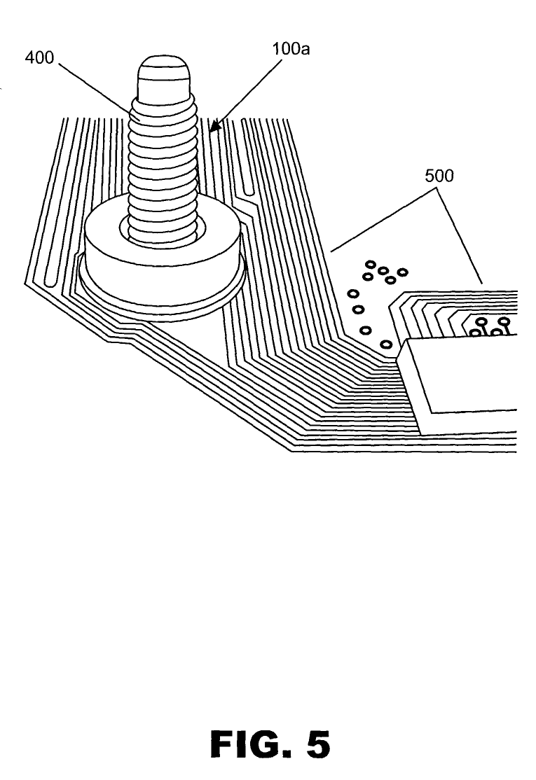

FIG. 5 is an illustration of an embodiment of the present invention in which a coated jackscrew (100a) is used to secure a printed circuit assembly (500). This illustration depicts the possible proximity of the printed circuit (500) and other electronic components to the jackscrew (100a). Due to this proximity, if any tiny fragments of metal were dislodged from the jackscrew (100a), they would easily and likely come in contact with the printed circuit (500) or other electronic components. As noted above, this would very likely cause a short or other malfunction in the circuit (500) or other components.

However, with the coating (400) applied on the screw (100a) according to the principles of the present invention, the release of any problematic metal fragments is minimized. Consequently, the reliability of the circuit (500) will be enhanced, even if the screw (100a) is frequently engaged and disengaged to allow maintenance or access to the circuit (500) or other components.

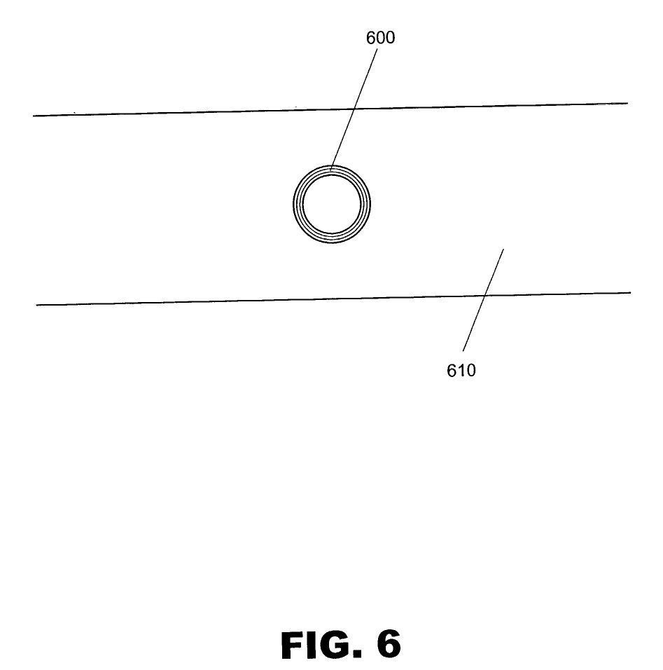

FIG. 6 is an illustration of a threaded hole (600) in a nut plate (610) in which the jackscrew (100a) may be engaged after being installed through a circuit board assembly (e.g., 500; FIG. 5). A printed circuit board may be secured in a chassis or housing with a jackscrew that extends through the circuit board and into a threaded hole (600) in a nut plate (610) that is secure to or part of the chassis or housing. The housing or chassis provides stability and protection for the electronic assembly that includes the secured circuit board.

The threaded nut plate (610) is preferably made of stainless steel. Stainless steel is a harder substance than the typical zinc coating on the threads of the steel jackscrew (100). It is due to this fact that the zinc coating of the jackscrew is frequently sheared off and becomes the main source of the metal fragments (220; FIG. 3) discussed above that contaminate and may damage electronic components, such as printed circuits (500; FIG. 5).

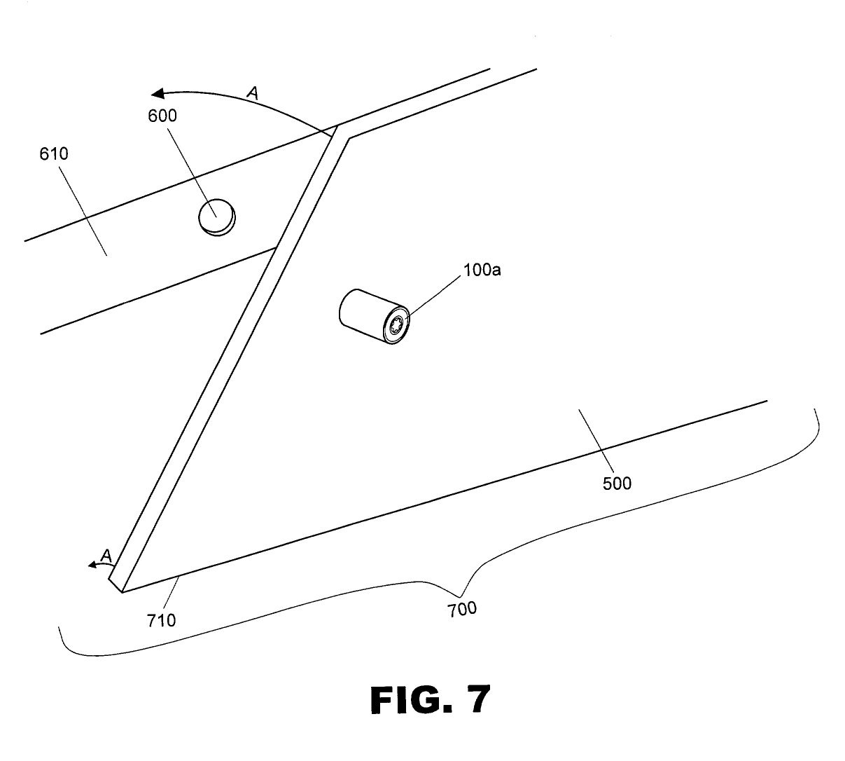

FIG. 7 illustrates an embodiment of the present invention in which a coated jackscrew (100a) is used to connect to a printed circuit assembly (500) to a chassis (610) or frame of an electrical device (700). After the printed circuit assembly (500) is correctly positioned, the jackscrew (100a) is tightened to secure the assembly (500) in place.

“A” represents the angle of rotation through which the printed circuit assembly (500) swings as it is correctly installed. This angle of rotation (A) results from the printed circuit assembly (500) pivoting about a pivot point (710) at the bottom of the printed circuit assembly (500). The printed circuit assembly (500) must rotate on this pivot (710) through the angle of rotation (A) in order to be installed correctly.

However, this angle of rotation (A) can also cause an off-axis alignment of the jackscrew (100) with the threaded hole (600) of the nut plate (610) located on the chassis. As mentioned above, this off-axis alignment can cause the jackscrew (100a) to be misthreaded as it is screwed into the threaded nut plate (610). This results in increased pressure and wear on the screw (100a). More specifically, this off-center installation of the jackscrew (100a) would normally cause the jackscrew to wear and could shear off metal fragments (220) from the jackscrew. However, with the implementation of a protective coating (400), such as Xylan® 1052, a lower coefficient of friction of the coating (400) causes the jackscrew (100a) to rotate more freely even with off-axis loading as caused by the rotation through angle “A.”

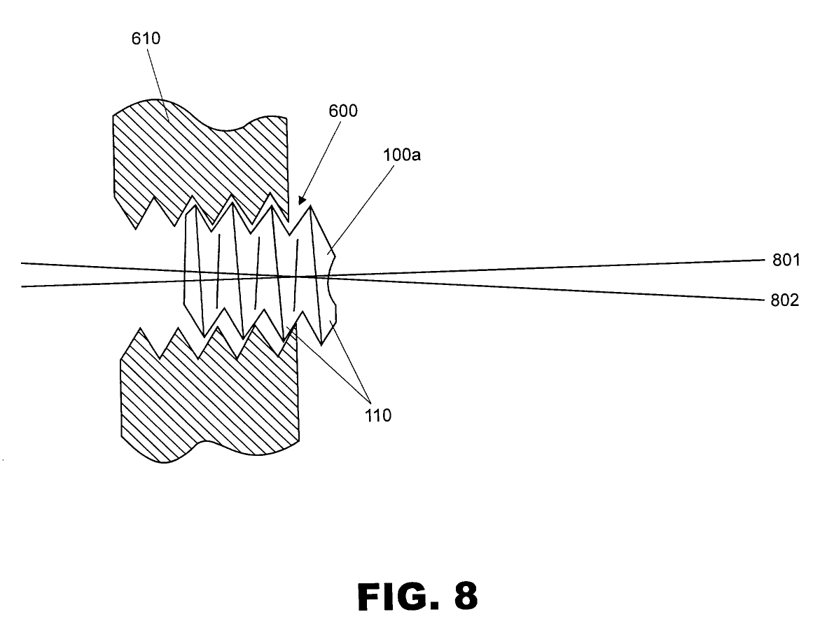

FIG. 8 further illustrates the situation in which a jackscrew is subject to off-axis loading. In order to properly thread a jackscrew (100a) into a threaded hole (600) of a nut plate (610), the axis of both the jackscrew (100) and the threaded hole (600) must be aligned. As illustrated in FIG. 8, the axis (801) of the threaded hole (600) and the axis (801) of the jackscrew (100a) are not aligned. This causes binding or striping of the jackscrew threads (110). The application of the protective coating (400), preferably being a Xylan® 1052 protective coating (400), causes the coefficient of friction to decrease and causes the jackscrew (100a) to twist more freely into the threaded hole (600) and to engage without binding. Thus, even though the screw (100a) is inserted “off-axis,” the problems associated with such off-axis loading and the resulting metal fragments are minimized.

The preceding description has been presented only to illustrate and describe the invention. It is not intended to be exhaustive or to limit the invention to any precise form disclosed. Many modifications and variations are possible in light of the above teaching.

The preferred embodiment was chosen and described in order to best illustrate the principles of the invention and its practical application. The preceding description is intended to enable others skilled in the art to best utilize the invention in various embodiments and with various modifications as are suited to the particular use contemplated. It is intended that the scope of the invention be defined by the following claims.

What is claimed is:

1. A jackscrew comprising:
a threaded shaft;
a head at one end of said threaded shaft; and
a protective coating disposed on threads of said threaded shaft,
wherein said protective coating prevents fragments from being dislodged from said jackscrew.

2. The jackscrew of claim 1, further comprising knurling on said head of said jackscrew.

3. The jackscrew of claim 1, further comprising a recess in said head of said jackscrew, said recess being sized and shaped to receive a tip of a tool for driving said jackscrew into or out of engagement in a threaded hole

4. The jackscrew of claim 3, wherein said recess is a star-shaped recess.

5. The jackscrew of claim 1, wherein said protective coating comprises Xylan® 1052.

6. The method of claim 1, wherein said protective coating has a lower coefficient of friction than said threaded shaft.

7. A method of making a jackscrew comprising:
forming a threaded shaft;
forming a head at one end of said threaded shaft; and
forming a protective coating on threads of said threaded shaft,
wherein said protective coating reduces a coefficient of friction of said threads and prevents fragments from being dislodged from said jackscrew.

8. The method of claim 7, further comprising forming knurling on said head of said jackscrew.

9. The method of claim 7, further comprising forming a recess in said head of said jackscrew, said recess being sized and shaped to receive a tip of a tool for driving said jackscrew into or out of engagement in a threaded hole

10. The method of claim 9, wherein forming said recess comprises forming a star-shaped recess.

11. The method of claim 7, wherein said forming a protective coating comprises coating said threaded shaft with Xylan® 1052.

12. The method of claim 7, wherein said protective coating has a lower coefficient of friction than said threaded shaft.

13. An electronic assembly comprising:
an electronic assembly;
a structure for supporting said electronic assembly; and
a jackscrew securing said electronic assembly to said structure, said jackscrew comprising:
a threaded shaft;
a head at one end of said threaded shaft; and
a protective coating disposed on threads of said threaded shaft,
wherein said protective coating prevents fragments from being dislodged from said jackscrew.

14. The electronic assembly of claim 13, further comprising knurling on said head of said jackscrew.

15. The electronic assembly of claim 13, further comprising a recess in said head of said jackscrew, said recess being sized and shaped to receive a tip of a tool for driving said jackscrew into or out of engagement in a threaded hole

16. The electronic assembly of claim 15, wherein said recess is a star-shaped recess.

17. The electronic assembly of claim 13, wherein said protective coating comprises Xylan® 1052.

18. The electronic assembly of claim 13, wherein said protective coating has a lower coefficient of friction that said threaded shaft.

19. A jackscrew comprising:
a threaded shaft;
a head at one end of said threaded shaft; and
protective means disposed on threads of said threaded shaft for reducing a coefficient of friction of said threads and preventing fragments from being dislodged from said jackscrew.

20. The jackscrew of claim 19, further comprising knurling on said head of said jackscrew.

21. The jackscrew of claim 19, further comprising a recess in said head of said jackscrew, said recess being sized and shaped to receive a tip of a tool for driving said jackscrew into or out of engagement in a threaded hole

22. The jackscrew of claim 21, wherein said recess is a star-shaped recess.

23. The jackscrew of claim 19, wherein said protective means comprise Xylan® 1052.
